(19) United States
(12) Patent Application Publication
(10) Pub. No.: US 2022/0243655 A1
(43) Pub. Date: Aug. 4, 2022

(54) FLAT PLATE AIRFOIL PLATFFORM VEHICLE

(71) Applicant: Galen Suppes, Columbia, MO (US)

(72) Inventor: Galen Suppes, Columbia, MO (US)

(73) Assignee: The Suppes Family Trust, Columbia, MO (US)

(21) Appl. No.: 17/591,034

(22) Filed: Feb. 2, 2022

Related U.S. Application Data
(63) Continuation-in-part of application No. PCT/US21/16392, filed on Feb. 3, 2021.
Application No. PCT/US21/16392 is a continuation-in-part of application No. 63/279,397, filed on Nov. 15, 2021.
Application No. 63/279,397 is a continuation-in-part of application No. 63/212,138, filed on Jun. 18, 2021.

(51) Int. Cl. F02C 6/20; B64D 27/24; B64D 27/16; F02C 3/04; H02K 1/12; H02K 17/12

(52) U.S. Cl. CPC F02C 6/20; B64D 27/24; B64D 27/16; B64D 2027/026; H02K 1/12; H02K 17/12; F02C 3/04

(57) ABSTRACT

A motor (more-broadly, induction device) is based around stacked rotor and stator boards rather than coils. The advance is analogous to using circuit boards rather than wires. Distinct advantages exist when the circuit board motor embodiment is combined with a novel open-burner combustor to form a hybrid electric-fuel jet engine (a culmination of three embodiments). The preferred application of the hybrid fuel-electric engine is in highly efficient (high lift-to-drag) aircraft utilizing towed platforms having high surfaces areas for both generating lift and collecting solar energy. The final combination yields advantages for an aerial platform towed via a front hinge joint that enables both vertical takeoff/landing and advantageous failsafe landing options. The aircraft is preferably powered by the hybrid electric-fuel jet engine.

### CROSS REFERENCE TO RELATED APPLICATIONS

This application is a continuation-in-part of Provisional Appl. Ser. No. 63/212,138 filed on 18 Jun. 2021 entitled “Pod-Based Towed Platform Drone”, Ser. No. 63/279,397 filed 15 Nov. 2021 entitled “Multicopter with Improved Propulsor and Failsafe Operation”, and App. No. PCT/US21/16392 filed on 3 Feb. 2021 entitled “Flat Plate Airfoil Platform Vehicle”. The above-listed applications are incorporated by reference in their entirety herein.

### FIELD

The present invention relates to effective lifting body designs for aerial drones and light-weight propulsion systems including light-weight motors. More specifically this invention relates to with emphasis on flight efficiency, VTOL drones, hybrid electric-fuel engines, solar power, and methods of improved safety and energy efficiency.

### BACKGROUND

Alternative approaches to design can enable paths of innovation. The embodiments of this document apply continuity equation approaches to aircraft, electric motors, and engines with the resulting surface-based analyses and control volumes leading to parallel paths of innovation. In aerial drone technology the paths of innovation have both originated and converged to provide lighter-weight and more-efficient aircraft and respective propulsors. Extended discussions are available in above-cited priority art.

### SUMMARY OF THE INVENTION

Embodiments of the present invention use flat plate airfoils with stability enhanced by towing via contiguous spanwise axial joints near the leading edge of the airfoils. Preferred hybrid-electric engines use motor architectures analogous to applying circuit board design approaches to rotors and stators which are coupled with jet-turbine-type engines that replace combustor walls with rotating blade and aerodynamic containment of combustion pressures.

### BRIEF DESCRIPTION OF THE DRAWINGS

FIG. 1 is an illustration of flying towed platform train with insert of solar cell array.

FIG. 2 is a cutaway view of a hybrid electric-fuel engine with open-burner engine.

FIG. 3 is a cross section of a hybrid electric-fuel engine.

FIG. 4 are cross section view of various blade configurations for open-burner engine.

FIG. 5 illustrates cross sections of: a) A composite truss with belt tensile element, b) 3D-printed injection mold connections, and c) 3D-printed injection mold of a structural beam.

FIG. 6 is a single-circuit stator disc with a) outside, b) inside terminals, and c) two disc stacking to form 1.5 loop coils.

FIG. 7. are cross section view of various surfaces of stator system induction circuits.

FIG. 8 illustrates various induction circuits, core, and shielding configurations.

FIG. 9 illustrates a stator and rotor in fast stack and slow stack configurations.

FIG. 10 is an illustration of 3-phase stacked induction configurations (stator or rotor).

FIG. 11 illustrates various transformer drone and liftpath embodiments.

FIG. 12 illustrates configurations form platform train to transformer drone.

FIG. 13 illustrates platform liftpath with pair of tiltwings on a forward joint.

FIG. 14 illustrates a transformer drone with trailing end slot for mounting pods.

FIG. 15 is an illustration of a transformer drone with a towed platform compartment.

FIG. 16 illustrates conductive laminate sheets and connections.

FIG. 17 is a flying towed platform train of FIG. 1 illustrating lead vehicle, primary aerial towed platform, and second aerial towed platform as disconnected units.

FIG. 18 is an illustration of a flat plate airfoil aircraft with four stacked platforms on the primary flat plate airfoil platform.

FIG. 19 is an illustration of part of one side of an aerial towed platform as a) two sides stacked one top the other and b) a single side.

FIG. 20 is an illustration of the trailing end of the side with a lower guide and bumper.

FIG. 21 is an illustration of flying towed platform train.

FIG. 22 is an illustration of a towed aerial platform attached above a fuselage.

FIG. 23 is an illustration of an aerial drone with a towed platform compartment.

FIG. 24 is an illustration of a transformer drone in three failsafe configurations.

FIG. 25 is two illustrations of alternative transformer drone configuration.

FIG. 26 is an algorithm for active control of platform pitch relative to wing pitch.

FIG. 27 is a quadcopter with two front tiltwings.

FIG. 28 is a quadcopter with tiltwing, middle wing, and trailing edge wing.

FIG. 29 is a front view of a hybrid electric fuel ramjet engine.

FIG. 30 illustrates views of rotating combustor nozzle in compressor blade assembly.

FIG. 31 illustrates alternative views of FIG. 2 hybrid electric-fuel engine, including: a) an exploded view, b) a trailing end perspective, and c) a leading end perspective.

FIG. 32 provides a) an alternative perspective view of the FIG. 10b induction device and b) an exploded view of the FIG. 10b induction device.

FIG. 33 illustrates a coupling of an excitation means with an induction circuit system.

### DESCRIPTION OF INVENTION

An aerial vehicle with propulsor and according to various aspects of this present invention in the most-preferred form employs: 1) an airframe with the following features: a) an aerial towed platform, b) a liftpath comprising a tiltwing pivotably coupled to a lifting body surface, and c) a pseudo-autorotation failsafe configuration comprising a front tiltwing and 2) a preferred propulsor with the following features: a) a hybrid electric-fuel jet engine comprising an open motor core, b) an induction device comprising circuit board inductors, and c) an open-burner engine 60. FIG. 1 illustrates the preferred vehicle, and FIG. 3 illustrates the preferred propulsor.

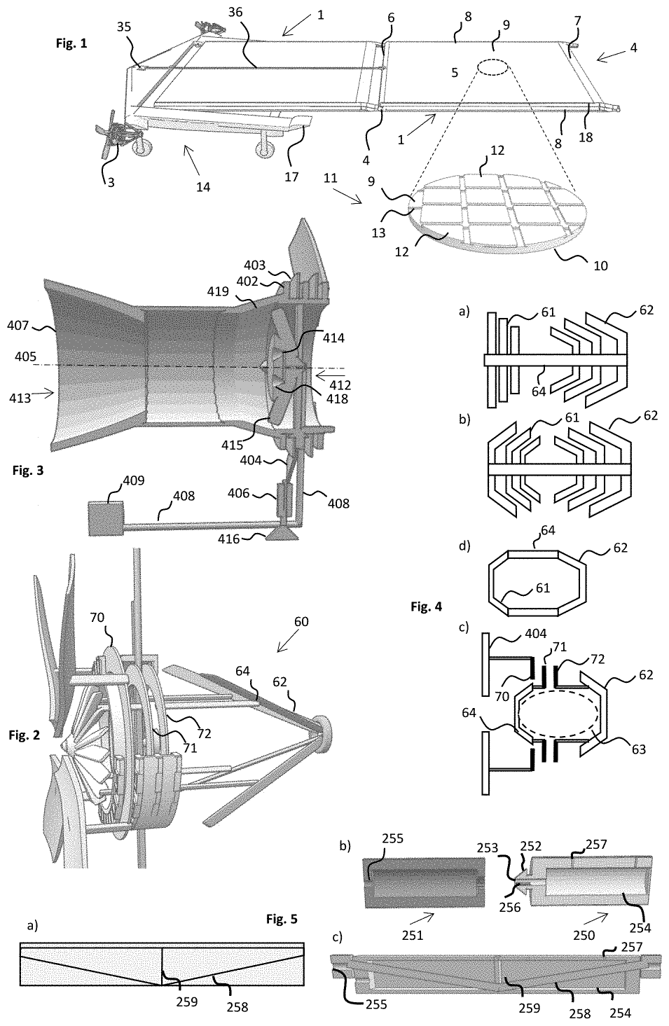

Preferred Propulsor—The preferred propulsor comprises an open-burner engine 60, said engine comprising compressor blades 61, expander blades 62, and a combustion pressure volume 63. The combustion pressure volume comprises a fluidic radial surface (versus a solid wall of traditional combustors). The engine is configured so that rotating blades (compressor, expander, or a combination) contain at least one third of the fluidic radial surface. Optionally, the rotating blades may contain at least one half of the fluidic radial surface. Optionally, at least half the fluidic radial surface is contained by aerodynamic forces; wherein, the aerodynamic forces are produced by a combination of rotating blades and air flowing around the engine. As illustrated by FIGS. 2, 4, and 31; the blades extend radially and longitudinally; the longitudinal component of the extension provides radial surface containment. Stator walls may also provide solid wall containment to supplement the aerodynamic radial surface containment.

Preferably, at least half the said volume 63 is either not contained by a surface or contained by a combination of a compressor comprising the compressor blades 61 and expander comprising the expander blades 62; and, rotation of the compressor blades is coupled (e.g. by a coupling 64) with a rotation of the expansion blades. A coupling means may be s selected from the group comprising: a shaft, a connection at the outer radius of rotation of at least one of the expander blades, and a magnetic induction device such as an electric motor; the compressor may be selected from the group comprising: a turbine, a propeller, and a fan; the expander may be selected from the group comprising: a turbine, a propeller, and a fan; the engine may be selected from the group comprising: a jet engine, a gas turbine, and hybrid electric-fuel jet engine; and the engine may be configured to produce propulsion, shaft work, electromotive force, or other useful forms of power.

Preferably, the compressor is a leading compressor, the expander is a trailing expander, and the combustion pressure volume 63 is longitudinally located between the compressor and expander. More preferably, the engine comprises a plurality of pressure volumes including an outer pressure volume and an inner pressure volume; the inner pressure volume is fully contained in the outer pressure volume and has a higher pressure than the outer pressure volume. Combustion occurs in the inner pressure volume; and said inner pressure volume has an inner expander trailing the inner pressure volume, and the outer pressure volume as an outer expander trailing the outer pressure volume.

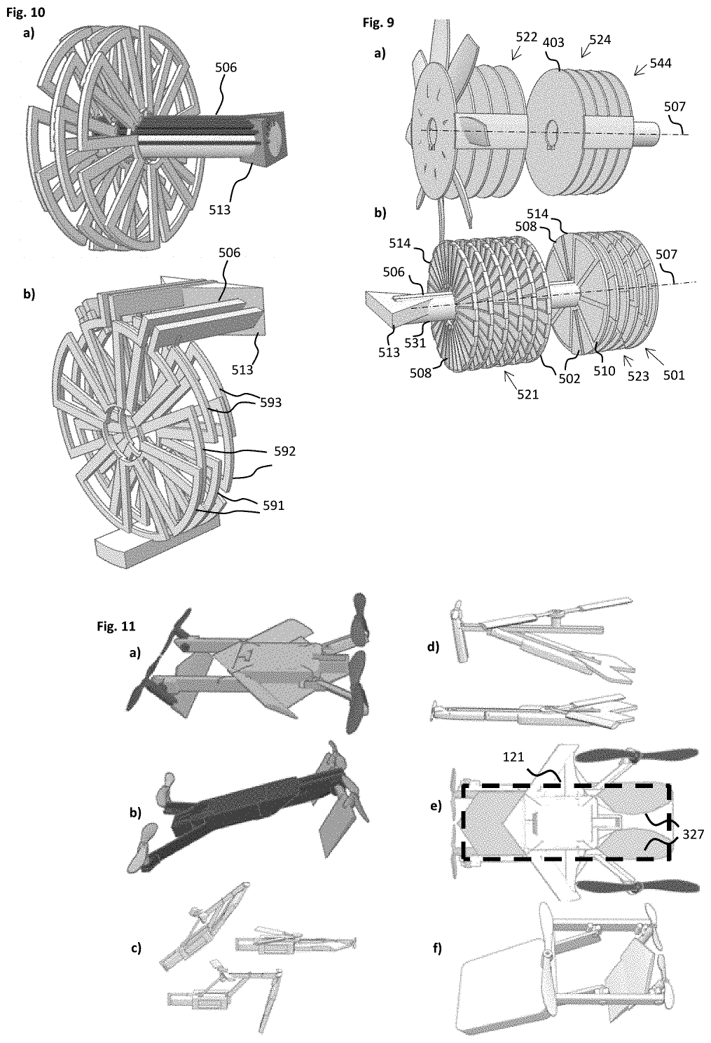

Preferably, the preferred propulsor comprises a hybrid engine capable of transitioning from electric-only power for takeoff to fuel combustion for extended range or speed; it is configured for flight with or without fuel use. The hybrid engine comprises an electric motor with a rotor (herein, rotor is an electric rotor as in “stator and rotor”) and a combustor; the electric motor comprises an open motor core positioned around a longitudinal axis of rotation where air flows through said open motor core to the combustor and where said hybrid engine is configured to transition from electric-powered propulsion to propulsion with both electric and jet power. More preferably, the combustor is located between a leading compression section and a trailing expansion section. The leading compression section may be connected to a first rotor 71; the trailing expansion section may be connected to a second rotor 72; and the motor is configured to transfer power from the second rotor to the first rotor. The electric motor is an induction device that may be configured to: a) initiate propeller rotation, b) supplement jet engine power, c) recover energy from propeller rotation as a generator, and d) transfer power from a trailing expander to a leading compressor through induction forces. A plurality of rotors in the engine may be enabled with a fast stator and a slow stator (see FIG. 9). A slow stator could be coupled to a propeller through a slow rotor (a third rotor 70).

Preferably, the combustor of the hybrid engine comprises a combustor configured to sustain fuel combustion (combustion expansion) in air having entering velocities greater than mach 0.8 followed by additional expansion in a bell nozzle 407 trailing the combustor. The bell nozzle is configured to expand combustion gases. A compression blade assembly is preferably configured absorb an impulse force generated by acceleration of gases during combustion (see FIG. 3). Preferred configurations include: a) a motor configured to initiate propeller rotation, b) a motor configured to supplement jet engine power, c) a generator configured to recover energy from propeller rotation, and d) an induction device configured to transfer power from a trailing expander to a leading compressor. Air enters the combustor along compressor blades 415 that may be powered by the impulse of combustion near the combustion bell 418; or alternatively, the compressor blades may be powered by electrical energy such as would be provided by solar panels on an aircraft.

Induction Device—An induction device is a stator system coupled to a reaction element such as a rotor system. A preferred induction device is a motor, but in the broader sense, the induction device of this invention is a device that uses induction circuits on boards to generate electromagnetic induction forces to move reaction elements. Example induction devices are: rotary motors, generators, brakes, dampers, linear motors, rotary induction motors, servos, axial flux rotary motors, and surrogate solenoid devices; and the stator system is configured to generate electromagnetic forces consistent with these devices. Example reaction elements are: rotors, sliders, lever arms, ferromagnetic rods, circuits, and other conductive surfaces configured to generate induced current. Preferred inductions devices have modular designs. Said inductor device may also be referred to in part, or in entirety, as: a stator system, an induction circuit, or an inductor circuit board.

The preferred motor comprises a stator system. The stator system comprises a plurality of stator discs 521 523 configured about a common axis. Stator discs of the plurality of stator discs may be spaced apart, defining gaps therebetween, and each stator disc of the plurality of stator discs includes an induction circuit wherein the induction circuit does not cross itself along the common axis. The induction circuit comprises a plurality of radial-direction tracks 503, a plurality of angular-direction tracks 504, and a plurality of terminals; said induction circuit extending terminal-to-terminal. FIG. 8 provides example discs. FIGS. 9 and 10 illustrate stacked-disc configurations where discs are parallel and configured to direct magnetic flux in a path through adjacent cores of adjacent stator discs.

A circuit busbar 506 connects the plurality of stator discs to a controller 513. The circuit busbar provides electric power to the plurality of stator discs. A rotor system is axially aligned with the plurality of stator discs. The rotor system includes at least one rotor 403; the at least one rotor positioned in one of the gaps between stator discs of the plurality of stator discs.

Preferably: a) the circuit busbar further comprises a stationary shaft 531 or a housing; b) a rotary device is one from a list comprising an electric motor, an electric generator, a pump, a propulsor, propeller, a hybrid jet engine, a rotating shaft, a synchronous electric motor, and an asynchronous electric motor; c) the rotary device includes a sensor, a source of electrical power, a control unit, and a cooling fluid flowing adjacent to disc surfaces, and d) each stator disc of the plurality of stator discs includes a plurality of stator-disc cores 516 through which at least one of ferromagnetic composite, ferromagnetic metal, air, and water may be housed. Example cooling fluids are ambient air or ambient water. A core material is a material through which an electromagnet induces magnetic flux. A core may be a ferromagnetic material, air, water, or essentially any material. The properties of the core impact the properties of the flux generated by an electromagnet. The rotary device's control unit and sensor, with connection to the power supply, may be combined in a motor control unit 513. Preferably, the cooling fluid flows in the gaps between stator boards; the cooling fluid flows along the interface surface between stator boards and gaps. In a preferred configuration, more than half of electrical resistance heat flows directly from the circuit to a cooling fluid across said interface surface. This direct flow may include flow through electrical insulation and is distinguished from indirect flow such as heat flow that goes through a core material between the circuit and cooling fluid.

Several options exist for the at least one rotor system. The rotor system may include: conductive metal surfaces (e.g. discs) 524, a primary coil coupled to a rotating secondary coil and attached to a housing, an induction circuit 545 510 (a continuous conductive track from connector to connector), a permanent magnet, and a magnetic bearing through interaction with stator induction circuits 510. The preferred rotor system is configured to be turned via electromagnetic induction forces in two-phase, three-phase, four-phase, or six-phase induction motor configurations; said configurations comprising distinct angular orientations of the stator discs 502 aligned along the common axis.

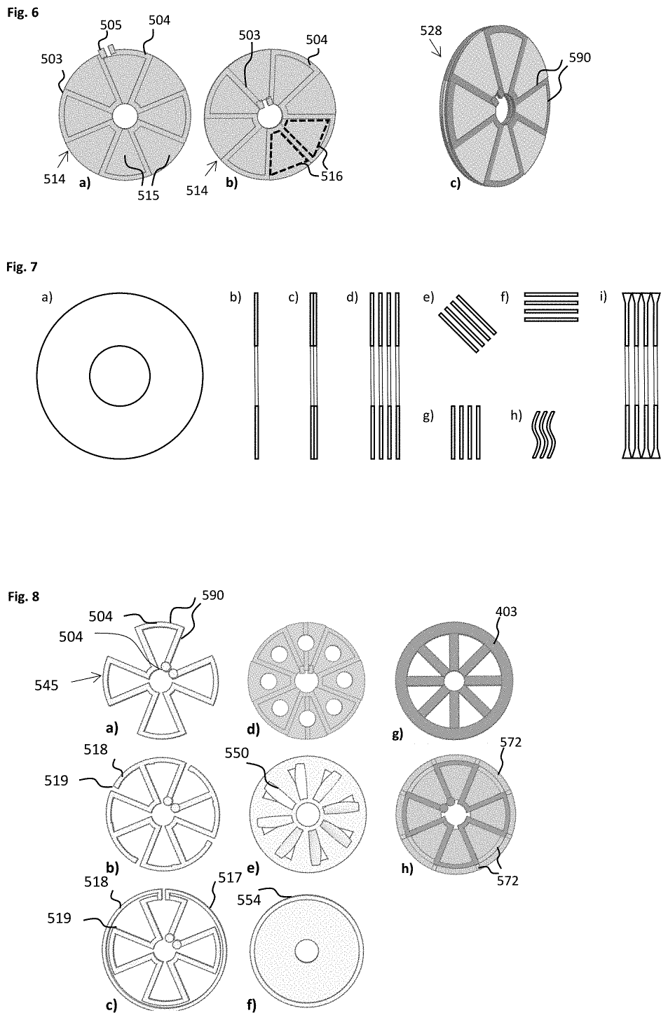

Preferably, the induction circuit further comprises multiple circuit sections 516, each circuit section including two radial-direction tracks 503, one angular-direction track 504, and a stator-disc core 515. Stated in an alternative manner, the induction circuit comprises a sequence 590 of a radial-direction track coupled to an angular-direction track, said sequence extending along a surface between said stator system. A fluid (e.g. air) separates rotor and stator surfaces. At least one of the circuit sections of the induction circuit may include a conductive track extension 518 and a conductive discontinuity 519 adjacent the conductive track extension. The conductive track extension 518, two of the radial direction tracks, one of the angular direction tracks and the conductive discontinuity 519 form a perimeter that surrounds the stator-disc core. Also, a conduction lip on a rotor disc may be used to provide flux shielding. The conductive discontinuity 519 may be between conductive track extensions 518 from the two radial-direction tracks 503 or between outer ends of radial-direction tracks 503 and a conductive track adjacent to the stator disc's outer perimeter. As illustrated by FIG. 6, the induction circuit comprises a sequence of a radial-direction track coupled to an angular-direction track in a repeated sequence in the angular direction.

The circuit tracks are preferably conductive metal (e.g. copper) strips where electrical insulation is applied to the outer surface of the metal as known in the science to prevent electric current flow outside the metal strips. An example fabrication method is comprised of: a) laser cutting the induction circuit 510 from sheet metal, b) dip coating of the induction circuit 510 in a resin that forms an insulating layer, and c) injection molding of the stator-disc core 515 between the sides of the induction tracks at locations where it is desired to have electromagnet core material (often referred to as a composite core).

As common in the science, symmetry is preferred in design, such as disc sections being substantially axially symmetric around the axis of rotation 507. Terminal connections and odd-numbered sequences may not be symmetric. Also, a constant change/interval in angular orientations is preferred for the induction motor phase configurations.

Optionally, motors comprise a slow grouping and a fast grouping, each of the slow 521 and fast groupings 523 including at least one stator disc of the plurality of stator discs and at least one rotor of the rotor system; wherein the rotor system further includes at least two rotors; wherein the at least one stator disc of the slow grouping has a different number of circuit sections within the induction circuit than the number of circuit sections within the induction circuit of the at least one stator disc of the fast grouping; and wherein the at least one rotor of the slow grouping rotates at a different speed than the at least one rotor of the fast grouping.

Preferably: a) the motor comprises a plurality of induction circuits; b) the plurality of stator discs are fabricated by at least one of 3D printing, metal stamping, laser cutting of sheet metal, or pressing of a metal wire; c) two stator discs from the plurality of stator discs are adjacently mounted on the circuit busbar forming a 1.5 loop stacking, the 1.5 loop stacking having an induction circuit with four radial direction tracks, an inner angular direction track, and an outer direction track, and d) the motor comprises a 1.5 loop stacking 528 (see FIG. 6c). Preferably, longitudinally-adjacent induction circuits 528 share common and continuous electromagnet cores. More preferably, except for where the induction circuits cross, conductive tracks of the back induction circuit are configured longitudinally thicker to reach the same surface for heat transfer; therein, maintaining a configuration that minimizes passing of circuit resistance heat through core material. FIG. 10 illustrates multiple pairs of adjacent induction circuits configured to generate magnetic fields at different phase angles.

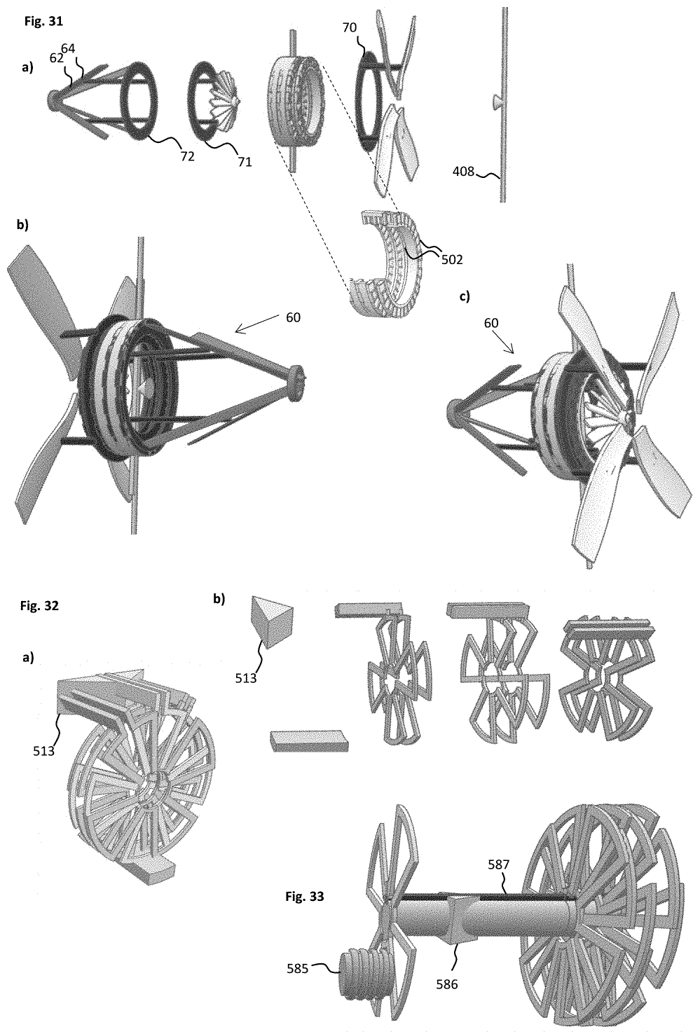

Preferably, the stator system comprises a first induction circuit having first axial tracks and a second induction circuit having second axial tracks; the first axial tracks parallel to the second axial tracks. The axial tracks form perimeters around most of the cores; and preferably, induction circuits in rotors and stators are geometrically similar forming core perimeters of similar size and geometry which leads to induction of current flow in the rotor induction circuits. For a three phase induction motor, rotors with induction circuit are preferably in a sequence of first phase 591, second phase 592, and third phase 593 with a repeat of that sequence 591 592 593 (see FIG. 32). Preferably, pairs of rotor boards are placed between pairs of stator boards except for single stator boards on the ends. An iron backplate may be placed on the two longitudinal ends of a stacked stator system; the iron backplate may have thickness conforming to provide a constant magnetic flux density; and a coil may be places around a portion of iron backplate to provide excitation voltage. Here, flow of current is to be distinguished as an organized current versus random Eddy currents.

A control unit 513 may be used to change from one rotor electrical connection configuration to another. Disks need not be of uniform thickness, could become increasingly thin on outer radius for a rotor, stator can actually meet to stop leakage (see FIG. 7i).

Adjacent induction circuits may be configured to generate magnetic fields at different phase angles. A preferred generator is an induction generator and comprises a rotor of substantially the same configuration as the stator, only the rotor is configured to rotate (see FIG. 10). If excitation current is provided to the rotor by a means connected to the rotor control unit (see FIG. 10), power is provided by the stator. If excitation current is provided to the stator, power is provided by the rotor. Excitation may be provided by configurations known in the science, such as: a) shunt or self excited, b) excitation boost system, c) permanent magnet augmentation, and d) auxiliary winding. FIGS. 10a and 10b illustrate a three-phase configuration with three pairs of adjacent induction circuit discs. Whether an inner busbar (FIG. 10a) or outer busbar (FIG. 10b), and the configurations may be a rotor or a stator; whereby, the phase angles and induction circuit core sizes of a rotor-stator combination should match such as illustrated by FIG. 10. In the motor mode of operation, the stator control unit controls power to stator and the stator control unit connects terminals the two terminals of each induction circuit. For an induction circuit has repeats an sequence of angular-direction duct connected to a radial-direction duct every 90 degrees, the phases of a 3-phase are offset 30 degrees. FIG. 10 illustrates a S1S2R1R2-S3S1R3R1-S2S3R2R3 sequence, where S is stator, R is rotor, and 1-3 are phases. The phase offset is the degrees in the repeated pattern divided by the number of phases. FIG. 8g provides an alternative rotor configuration comprised of inner and outer circular induction tracks connected with radial tracks; this configuration is simpler, but does not allow for generator operation.

While instant document commonly refers to the stator disc as a circuit board inductor on which preferred induction devices are based, the geometries of circuit boards are not limited to discs. The more-general specification comprises angular-direction tracks that are in a plane of rotation at a specific radius. Radial-direction tracks may deviate from said plane of rotation. The boards have board-fluid interface surfaces of symmetry about an axis (i.e. axial symmetry) in a configuration that allows rotation of a rotor at low tolerance (i.e. spacing) next to a stator board. In a more-general embodiment, the degrees of rotation of the rotor may approach zero at a high radial dimension, where movement of the rotor approaches being linear relative to the stator board (i.e. a linear motor). Likewise, the induction circuit may extend to increasingly low degrees in the angular direction where angular and radial dimensions appear as length and width dimensions. FIG. 7 provides radial cross section views and axis (i.e. front) views of stator board inductors alternative to discs.

Circuit board inductor construction of devices has a number of performance advantages, and preferred devices are configured to provide at least one of the group: a) improved heat transfer by transferring over half if circuit resistance heat directly across the interface surface (versus through a core material), b) ease of creating diverse configurations to optimally direct magnetic fluxes by repelling flux fields with conductive particles in a polymer matrix 571 and focusing flux fields with ferromagnetic materials 572 (see FIG. 8h), c) high power densities using thin stators and rotors resulting in high interface areas per volume, d) novel phase angle stacking for induction rotors, e) novel configurations to gradually or suddenly change stator torque or speed/rpm in axial direction to drive different rotors sharing the same stator busbar, f) improved heat transfer by minimizing the amount of electrical insulation in the primary paths of heat transfer, and g) ease of creating diverse configurations with functional devices connected integrated into the rotor construction.

A rotor does not have to be continuous; or example, the rotor could be ends of fan blades at a slight angle with at least one blade in a stator board that traverses less than 180 degrees in the angular dimension.

Aerial Vehicle—An aerial vehicle according to various aspects of this present invention employs an aerial towed platform 1 comprising a flat plate airfoil 2 pivotally connected to a propulsion means having a propulsor 3 through a forward joint 4. The flat plate airfoil 2 comprises a sheet 5, a rounded leading edge 6, a trailing edge 7, an average chord length, two sides 8, an average span between the sides 8, and a distributed load. The sheet 5 has an upper aerodynamic surface 9 for generating lift and a lower aerodynamic surface 10 for generating additional lift. The flat plate airfoil's average chord length is greater than its average span.

A preferred distributed load is an evenly distributed load comprising an array 11 of solar cells 12 on the upper aerodynamic surface 9 of the sheet 5 with the array 11 comprising a circuit 13 connecting the solar cells 12. Preferably, the propulsion means is at least of one of a lead aircraft 14, a linear motor 15, and a tractor. Preferably, the forward joint 4 is at least one of a hinge joint, a pin joint, and a ball joint. FIG. 1. illustrates a lead aircraft 14 pulling the aerial towed platform 1 with a liftpath traversing two pivotable connections. Example sheet 5 materials are a canvas, a metal sheet, a composite sheet, a corrugated plastic, and a corrugated board; all characterized by a low thickness. The flat plate airfoil is an airfoil.

Towed configurations are inherently stable in pitch provided the forward joint 4 is toward the leading edge 6 of the towed platform 1. Preferably, the forward joint 4 is has a lateral axis of rotation in the front 25% of the platform; more preferably within the front 10% of the platform 1, or optionally, extended in front of the leading edge (see FIG. 11). In this configuration, aerodynamic forces generate lift torque that balances load at a steady-state flight pitch without need for active control of the pitch angle.

A rectangular flat plate airfoil that has pitch instability becomes inherently stable when towed via a forward joint. Preferably, the tiltwing 30 has a control means selected from the group: flaps, ailerons 17, elevons, and horizontal stabilizers; the control means 16 controls at least one of roll, pitch, and yaw. Preferably, a pivot resistance device 41 limits the degrees of pitch of the flat plate airfoil 2 relative to the tiltwing 30 to less than 45 degrees. Examples of a pivot resistance devices includes hinge springs, pads 33, bumpers, and springs; all of which functionally limit the degree with which the flat plat airfoil is able to rotate relative to the tiltwing 30. For runway takeoff, the pivotal resistance device limits the nose-up pitch of the tiltwing to less than 20 degrees more than the towed platform, more preferably less than 20 degrees.

A flying towed platform train is comprised of a lead aircraft 14 followed by a primary aerial towed platform 31 followed by at least a second aerial towed platform 33. Platform average thickness is preferably less than one fifth the platform's width, more preferably less than one tenth. Methods known in the science and art may be used to provide smooth and streamlined air flow along platforms in a train sequence. For example, a lateral leading edge of a platform may contact the trailing lateral edge of the body in front of said platform; such a connection is referred to a aerodynamically contiguous.

Embodiments of this invention may be towed by a linear motor 15 propelling along an overhead monorail. A flat platform may be spaced (i.e. comprising a gap) above (or below) a fuselage with the vehicle configured for that space to decrease as velocity increases. A fuselage may have a platform or multiple wings attached on its lower (or upper) surface.

Flat plates attached to a fuselage, preferably, are rectangular and have spans at least 50% greater than the median width of the fuselage 44. Preferred cruising pitch angles are preferably between 0.2 and 5 degrees, and more preferably between 0.5 and 3 degrees. The platforms of FIG. 1 are liftpaths, and sequential platforms may align to form a longer liftpath. Alternative to a front tiltwing, a propulsion means may extend laterally from a hinge joint in the front 25% of the platform and impart advantages of stability for flat platforms that are otherwise unstable in flight (see FIG. 13). FIG. 11 illustrates an aerial vehicle with platforms in cruising, VTOL, and pod configurations.

“Liftpath” is a term used to define efficient lift surfaces other than traditional airfoils; it is described and defined in U.S. Pat. No. 10,589,838 B 1 and provisional applications cited therein. Liftpaths include aerodynamically-contiguous surfaces having air angle of attacks from 0 to 3 degrees (leading-edge up surfaces of low pitch) on relatively flat rectangular surfaces that are longitudinally longer than laterally (i.e., spanwise) wide. Structural or control surfaces such as actuators and ailerons (17, 18), arms (24, 26, 42, 43, 46, 47, 140), support surfaces (23), wing or blade sections, stabilizers (16), and rudders (17) (see FIGS. 1, 11, and 15) may extend from a liftpath. The swaywing is located below the airchassis and pivotably coupled to the airchassis. Platform 1 88 surfaces 9 10 93 are examples of liftpaths. More preferably, liftpaths have an average platform width greater than ten times an average platform thickness, and liftpahts have median platform lengths greater than the median platform widths.

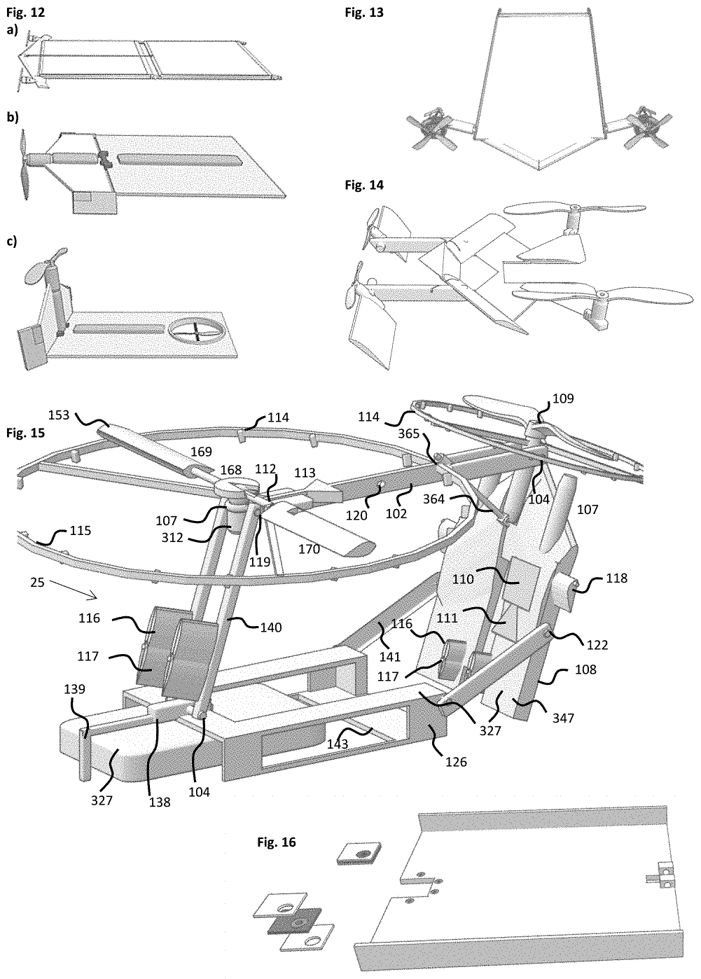

Front Tiltwing—Three features tend to be common between the aerial towed platforms embodiments of the previous paragraphs and transformer drone embodiments of the following paragraphs. Firstly, the embodiments rely on liftpaths for aerodynamic lift more than laterally-extending fixed wings. Secondly, a front tiltwing is preferred. Thirdly, most transformer drone embodiments have a platform with a forward joint connecting to a front tiltwing. And so, many of the configurations described for a transformer drone may be practiced on a vehicle comprising an aerial towed platform, and visa versa such as illustrated by FIG. 12. FIG. 15 illustrates a drone comprising a towed payload compartment platform 88 and a forward joint 89 similar to the towed platform 1 previously described.

FIG. 12c illustrates a trailing propulsor which has an orientation that is preferably coupled to the orientation of the front tiltwing through a cable, push rod, or other means running along the towed platform.

FIG. 11f illustrates a transformer drone with a payload compartment platform. The transformer drone is a multicopter comprising a multicopter airchassis 102; a forward tilting body 103 pivotably connected [bearing 104] to the airchassis 102 and configured to pivot between a first position 105 associated with a hover flight mode and a second position 106 associated with a forward flight mode.

The preferred transformer drone embodiment is a multicopter comprising: a) an airchassis; b) a front tiltwing pivotably coupled to the airchassis; the front tiltwing including: (i) a first propulsor configured to generate at least one of thrust or lift and (ii) an aerodynamic lift surface; c) a counterbalance propulsor system coupled to the airchassis, the counterbalance propulsor system configured to balance gravitational, aerodynamic, thrust and lift forces and torques caused by the front tiltwing, the counterbalance propulsor system including a second propulsor configured to generate at least one of thrust or lift; and d) a control unit. Multicopter configurations may include two to more than four propulsors. FIGS. 11a and 14 illustrate multicopters with two trailing end propulsors mounted on a trailing end wings; FIG. 14 illustrates the additional feature of pod loading and unloading access from the trailing edge.

Preferably, aerial vehicles (including multicopters) comprise a plurality of longitudinally-extending lift-generating surfaces 327 forming a total aerodynamic lift surface area; the plurality of longitudinally-extending lift-generating surfaces including tiltwings, arms and lifting bodies such as fuselages with fuselage lifting-body surfaces, freewings, and swaywings as illustrated by FIGS. 11 and 15. More preferably a multicopter comprises the fuselage, the front passively-adjusting tiltwing, an arm mechanically connecting the front passively-adjusting tiltwing to the fuselage, and platform surfaces 9 10. The plurality of longitudinally-extending lift-generating surfaces align to form a liftpath in a cruising configuration. Preferably, a single front tiltwing is in front of a single fuselage. Preferred is lift of the front passively-adjusting tiltwing at less than half the lift provided by the total aerodynamic lift surface area. Stated in alternative terms, tiltwing lift is less than half the total multicopter weight. Swaywings and freewings of this invention are types of fuselages. For vehicles without a swaywing or freewing, the airchassis is part of the fuselage.

Preferably, the airchassis, front tiltwing, and counterbalance propulsor system are transitionable through passive actuation to a default failsafe descent configuration, the failsafe descent configuration is conducive to landing without catastrophic damage. A preferred failsafe landing is in a pseudo-autorotation method with a pseudo-hovering configuration. Pseudo-autorotation method means “sort of autorotation method” and refers a moderate power supply to the propeller during descent with an increased in power three to fifteen seconds before landing to soften the landing. A front tiltwing is located in front of the fuselage center of gravity, and the passive stability features of a front tiltwing causes formation of the auto-hovering configuration at forward velocities less than 50 miles per hour (mph) when there is negligible lift from the counterbalance propulsor and when lift-path lift is inadequate to maintain a cruising configuration.

Characteristics of failsafe landings include one or more of: a) the thrust generated by the first propulsor is increased to a value greater than the pseudo-hovering lift prior to landing, b) the control unit (or pilot) maintains the roll angle between about −20 degrees to about 20 degrees from horizontal, and c) a slight forward velocity during the pseudo-autorotation failsafe (see FIG. 10c) to facilitate control/stability.

A first failsafe method (FIG. 11c) comprises transitioning the front tiltwing to a position wherein the total vehicle lift is more than four times greater than the front tiltwing propulsor lift and the tiltwing propulsor thrust is at least eighty percent of the total vehicle thrust. A second failsafe method (FIG. 11c) comprises transitioning the front tiltwing to a position where the front tiltwing propulsor lift is greater than one third of the total vehicle lift and the tiltwing propulsor lift is greater than the total vehicle thrust (i.e. a ratio of vertical lift to horizontal thrust greater than one). Preferably, passive aerodynamic actuation transitions the tiltwing for the first failsafe method and second failsafe method. The passive aerodynamic actuation is a result of the inherent stability of the front tiltwing against stall where tiltwing propulsor thrust induces the failsafe mode. Preferred pseudo-autorotation increases and maintains lift from a propulsor or blade to >70%, preferably >99%, of the vehicle weight at least one second before impact.

The second failsafe method is enabled by a front tiltwing propulsor force vector that provides a minimum torque about that center of gravity. In general, minimum torque corresponds to the closest distance of approach of the extended force vector being less than half the median width of the aircraft fuselage.

Vehicles of failsafe methods may include aerial vehicles and multicopters. A VTOL vehicle of this invention uses a front tiltwing to transition from VTOL to cruising and to enable a failsafe/emergency landing method. The VTOL vehicles have an airchassis as a support structure that may be part of a fuselage or a separate structure. Embodiments apply to multicopters ranging two to more than four propulsors. FIG. 11 illustrates multiple multicopters capable of achieving VTOL failsafe landings using only a front tiltwing.

A rectangular geometry is defined with a length substantially straight as a streamlined air flow above the surface and a lateral width where said straight streamlined airflow traverses most of the length of the aerial vehicle. This substantially flat rectangular geometry may be within a larger flat surface having lateral and longitudinal extensions beyond that rectangular geometry that serve a variety of purposes.

Flat plate construction can be relatively inexpensive. Other advantages reside in the plate materials. Transparent plates can provide stealth. Laminates with a conductive layer (sheet or grid) sandwiched in insulation can provide electrical connectivity for an aircraft, including control signals superimposed of electrical power transmission (see FIG. 16). Also, sheets may have conductive tracks that are insulated from each other but with ability to connect to electrical devices on the aircraft; this allows for elimination of wires and provides a robustness when tracks are wide and redundant.

The forward joint on a towed platform provides performance advantage by providing stable flight for flat surface lifting bodies that are otherwise difficult to control. This is achieved by having the force on the lifting body be the driving force to a stable the desired configuration (i.e. the desired configuration is the stable configuration). A good metric to identify whether a lifting body surface design is in need of the front hinge joint to enhance stability is the area-weighted L:D of the entire surface of a towed platform. High L:D benefit from the forward joint. Herein, high is defined as >20:1 at the optimal cruising configuration. An area-weighted L:D approximation of cos (Φ)/sin(θ). (where S is surface area, θ is the angle of a longitudinal tangent line on the surface relative to a vertical line and Φ to is the angle of a vertical tangent line to the surface relative to lateral line, lateral is a spanwise dimension). For a horizontal flat surface, L/D is approximately 52.7/θ. For a side vertical surface, L/D is zero. For lower surfaces that slope upward toward the tail, the L:D is negative and takes away from performance. The weighting function is [cos (Φ)+0.01] so as to account for low form drag of side surfaces. And so, the lift-weighted L:D is the integral of [cos (Φ) ((cos (Φ)+0.01)/sin(Φ) dS] divided by the integral of [cos (Φ) ((cos (Φ)+0.01)/sin(θ) dS]. The preferred towed platforms of the towed platform embodiments an area-weighted L:D greater than 30:1; and more preferably greater than 40:1. The towed platforms of the transform drone embodiments are more relaxed in this metric at 20:1. An alternative metric is to use the actual L:D of the towed platforms or fuselages that are towed by a forward joint.

A vehicle with lateral tiltiwing connected in the front 25% of the lifting body surface (more preferably in or in front of the front 10%) and where over half (over 70% and over 85%) of the total lift (at air angles of attack between 0 and 3 degrees) is from a combination of upper and lower rectangular liftpaths on the lifting body surface. Liftpaths preferably extend at least 75% of the total vehicle length on both the top and bottom of the vehicle; more preferably at least 90% of the total length and at least 90% of the median width. In more general terms, the vehicle is a lifting body surface or combination of a plurality of surfaces that form aerodynamically contiguous and streamlined (laminar) air flow.

Additional Towed Platform Embodiments—For a perfectly flat sheet 5 with an evenly distributed load, the weight of the distributed load is equal and opposite lift locally and on the larger scale. This substantially eliminates stress on the sheet 5 during steady-state flight allowing use of light-weight sheet materials without structural reinforcement. This reduces load, reduces pitch, increases L:D, and leads to high energy efficiency. Preferred loads on the platform 1 is less than 5 lb per ft², more preferably less than 2 lb/ft², and most preferably less than 0.5 lb/ft².

A solar cell array 11 towed where torque passively balances about the forward joint 4 at the more-preferred pitch is able to collect greater than 20× the power needed to sustain flight (overcome drag). Example sheet 5 materials are a canvas, a metal sheet, a composite sheet, a corrugated plastic, and a corrugated board all characterized by a low thickness.

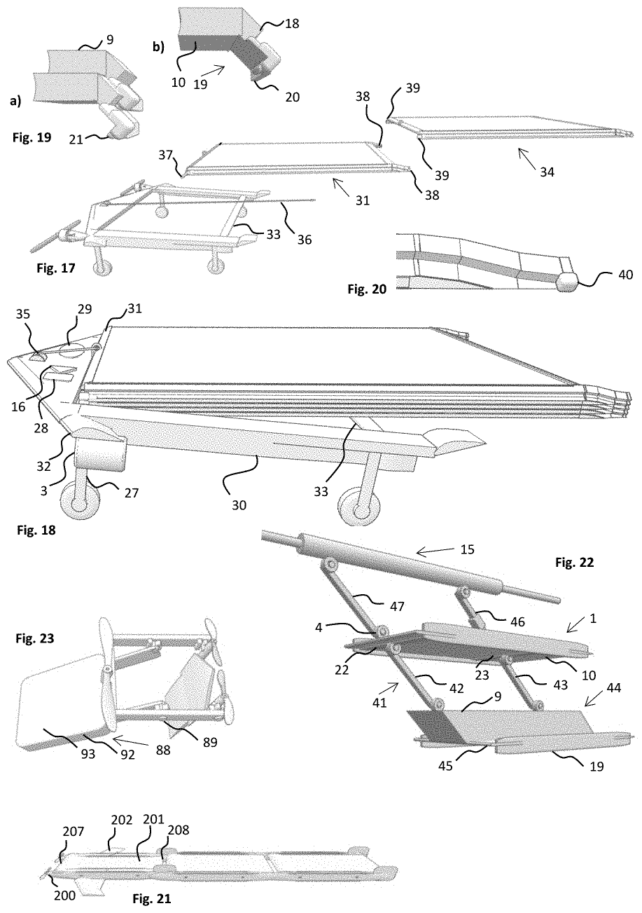

Multiple aerial towed platforms 1 may be pulled by one lead aircraft 14 forming a train which reduces form drag while having flexibility that increases robustness. FIG. 17 illustrates separate components that form a train. FIG. 18 illustrates a flat plate airfoil aircraft where multiple plates 1 are stacked to provide a more-robust structure for takeoff and landing FIG. 19 provides a close-up illustration of the side 8 and a stacked side.

Towed configurations are inherently stable in pitch provided the forward joint 4 is toward the leading edge 6 of the towed platform 1. Preferably, the forward joint 4 is in the front 25% of the platform; more preferably within the front 10% of the platform 1 or even extend in front of the leading edge (see FIG. 23). In this configuration, aerodynamic forces generate lift torque that balances load at the more-preferred steady-state flight pitch without need for active control of the pitch angle. While a towed platform has passive pitch, roll, and yaw stability; a preferred aerial towed platform 1 has a control means 16 comprising at least one of ailerons 17, flaps, and a horizontal stabilizer. Most-preferred is use of ailerons to reduce chaotic variation (e.g. response to turbulence) in the platform 1 pitch.

Preferably, the aerial towed platform 1 has sides 8 of vertical inclination wherein the sides 8 are at least one of guideways 18, fences 19, sealing air pocket perimeter 20, and guiding protrusions 21. Vertical components of sides 8 create resistance to lateral air flow.

The FIG. 1 illustration is side 8 design capable of being 3D-printed. For a 3D-printed side, the protrusion 21 may be a nub of plastic and the same side 8 may provide a guideway 18, fence 19, protrusion 21, and perimeter 20 to trap air between stacked platforms 1. Trapping of air between stacked platforms 1 can create a hovercraft type of action when extending or retracting platforms 1. Example guiding protrusions 21 are selected from a group wheels, slides, nubs, balls, and knobs that may follow a guideway 18. Example guideways are rails, raceways, and grooves.

FIG. 22 illustrates an application of the platform 1 alternative to solar aircraft. The distributed load of that platform 1 is distributed through a forward lateral structure 22 and a trailing lateral structure 23 where the forward lateral structure 22 pivotally connects to a forward arm 24 of a swaywing 25 on the lower aerodynamic surface 10. The trailing lateral structure 23 pivotally connects to a trailing arm 26 of the swaywing 25 on the lower aerodynamic surface 10. The swaywing 25 system is connected to a payload 29 compartment. In this configuration, a lateral tensile stress with a convex-upward camber is formed on the sheet 5 between the lateral structures 22 23 due to the lift forces. This camber structure is also light in weight and facilitates high L:D, provided the camber arc is minimal. U.S. patent application Ser. No. 16/783,319 provides further discussion of the swaywing.

Flat Plate Airfoil Aircraft—A problem with the rectangular flat plate airfoils is pitch instability during takeoff. If this instability is not addressed, the nose of an aircraft could flip up and over the trailing edge during takeoff. A preferred solution is a flat plate airfoil aircraft comprising a landing gear system 27, an energy storage means 28, a control system 16, a payload 29, and a tiltwing 30 pivotally connected to a primary flat plate airfoil platform 31 by a forward joint 4. The tiltwing 30 is comprised of at least one tiltwing airfoil 32, at least one propulsor 3, and a pitch control means 16; the energy storage means 28 is configured to power the propulsor 3; and the control system 16 is configured to control both the propulsor 3 and the tiltwing 30 pitch. An more-general version of the present embodiment is where the primary flat plate airfoil is a primary platform of platform type of FIGS. 1, 15 18, 23, 24, and 25.

In this embodiment, the pitch of the primary flat plate airfoil platform 31 is lower than the tiltwing 30 pitch at a runway takeoff velocity since aerodynamic forces lift the trailing edge of the flat plate airfoil platform 31 relative to its forward joint 14. Preferably, the tiltwing 30 has at least one of flaps, ailerons 17, and horizontal stabilizers wherein the control means 16 controls at least one of roll, pitch, and yaw.

Preferably, a pivot resistance device 41 limits the degrees of pitch of the flat plate airfoil 2 relative to the tiltwing 30 to less than 45 degrees. Examples of a pivot resistance devices includes hinge springs, pads 33, bumpers, and springs; all of which functionally limit the degree with the flat plat airfoil is able to rotate relative to the tiltwing 30.

Preferably, the pivot resistance devices 41 include at least one pad 33. Preferably, the landing gear system 27 is attached to the tiltwing 30, and the flat plate airfoil 2 rests on the pad 33 when the flat plate airfoil aircraft is parked. In this embodiment, tiltwing 30 is broadly defined as a device including a wing attached to a propulsor; and more specifically in this embodiment, it is substantially an aircraft in its own right where that aircraft is able to pivot to positive pitch relative to the flat plate airfoil (see FIG. 18).

For this flat plate airfoil aircraft, preferably, a second towed platform 34 is stacked above the primary flat plate airfoil platform 31, and the second towed platform 34 is extended behind the primary flat plate airfoil platform 31 during flight. Preferably, the flat plate airfoil aircraft includes a towed platform extension means 44 said towed platform extension means 44 comprising a guideway 18, a winch 35, a cable 36, and a guiding protrusion 21 said guiding protrusion 21 functionally following the guideway 18. Preferably, the payload 29 is attached to the tiltwing 30 and is at least one of batteries, fuel cells, fuel tank, communication electronics, radar, imagery equipment, aircraft hangar, aircraft, hydrogen tank, passenger cabin, freight compartment, pod transfer devices, passenger transfer cabin, spacecraft launcher, and chemical production process. The tiltwing 30 embodiment goes beyond the traditional definition of a tiltwing, up to and the option for including air frame, landing gear, and payload features as part of the tiltwing 30.

Flying Towed Platform Train—A flying towed platform train is comprised of a lead aircraft 14 followed by a primary aerial towed platform 31 followed by at least a second aerial towed platform 33. The primary aerial towed platform 31 includes a primary flat plate airfoil platform 31, a forward joint 4, a first forward connection 37, and a first aft connection 38; the second aerial towed platform 33 includes a second towed platform 34 and a second forward connection 39; and the primary and secondary flat plate airfoil platforms 31 33 are preferably aerial towed platforms 1 as described in first paragraph of Invention Description. The towed platform train includes at least the first forward connection 37 pivotally connected to the lead aircraft 14 and the second forward connection 39 pivotally connected to the first aft connection 38.

The preferred flying towed platform train includes arrays 11 of solar cells 12 on the upper aerodynamic surfaces 9 of the sheets 5 where the arrays 11 include at least one circuit 13 connecting the solar cells 12. At least one circuit 13 connects to the lead aircraft 14, and the solar cells 12 provide electrical power to the lead aircraft 14. The most preferred flying towed platform train includes a payload 29 connected to the lead aircraft 14

Longer train units may be formed by adding more platforms 1 connected similar to how the secondary platform 33 is connected to the primary platform 31 as illustrated by FIG. 21. When stacked on the primary flat plate airfoil platform 31, platforms higher in the stack may rest on those lower in the stack on pads attached to sheets of an average thickness to provide weight support through to a support structure under the primary platform 31. These pads may be of a low-friction material to allow platforms to slide off during extension. Also, an air pocket may be created between platforms to assist with extension by opening an air inlet between platforms with a resistance to air leaving the space between platforms by a sealing perimeter (e.g. like a hovercraft). Various locking mechanisms and keys along the cable may be used to sequentially extend the platforms in flight. It is also possible to attach platforms delivered by a delivery vehicle during flight. Platform average thickness is preferably less than one fifth the platform's width, more preferably less than on tenth.

When extending, protrusions 21 follow the guideways 18 first in a parallel path to the lower platform, but at the end of the guideway, the guideway bends downward so that sequential platform sheets are aerodynamically aligned (see FIG. 20). Methods known in the science and art may be used to provide smooth and streamlined air flow along platforms in a train sequence. A bumper 40 on the trailing end of the guideway stops further extension, and can form a pivotable joint in combination with a protrusion 21 and guideway 18.

Flying Train Overhead Monorail—The FIG. 22 transportation system 41 is comprised of a linear motor 15 propelling along an overhead monorail, an aerial towed platform 1 (as described in first paragraph of Invention Description) pivotally connected to the linear motor 15, and a swaywing 25 connection between the aerial towed platform 1 and a fuselage 44. The fuselage has a median width. The swaywing 25 is comprised of a forward fuselage arm 42 pivotally connecting a forward upper aerodynamic surface 9 of the fuselage to a forward lower aerodynamic surface of the aerial towed platform 1, a trailing fuselage arm 43 pivotally connecting a trailing upper aerodynamic surface 9 of the fuselage to a trailing lower aerodynamic surface of the aerial towed platform 1, and an air gap between the aerial towed platform 1 and the fuselage. As the linear motor pulls the platform 1 forward, forward velocity induces aerodynamic lift on both the aerial towed platform 1 and the fuselage 44 wherein the fuselage 44 swings toward the aerial towed platform 1.

Preferably, a fuselage flat plate platform 45 is attached to the bottom of the fuselage 44 and is configured substantially parallel to the aerial towed platform 1. The performance advantage of this transportation system 41 is a high L:D within a narrow transit corridor. The combined low pitch surface areas of the two platforms 1 45 and the fuselage's upper low-pitch surface 9 approximately double the low-pitch aerodynamic lift area. The highest L:D is achieved when the two platforms 1 45 are substantially parallel. An approximate doubling of overall L:D, due to a doubling of low-pitch surface areas, approximately doubles the fuel economy as compared to the fuselage and lower platform 45 alone.

Preferably: the forward arm 42 and trailing arm 43 are of equal length and parallel; the two platforms 1 45 have spans at least 50% greater than the median width of the fuselage 44; and both platforms 1 45 have fences 19 as part of their sides 8 to reduce lateral air flow. More preferably, the two platforms 1 45 have median spans between 1.5× and 3× the median width of the fuselage 44.

The gap between the fuselages upper surface 9 and the towed platform's 1 lower surface 10 decreases as velocity increases and the fuselage 44 swings back and up. The two surfaces may contact at higher velocities. Preferably, the maximum gap is between 0.4× and 3× the parked median pitch displacement of the upper platform 1 where pitch displacement is approximately the median length of the platform 1 multiplied times the pitch angle in radians. Preferred parked platform pitch angles are between 2 and 10 degrees and more preferably between 3 and 7 degrees. Cruising pitch angles are preferably between 0.2 and 5 degrees, and more preferably between 0.5 and 3 degrees.

Initial pitch angles are set by the length of a trailing motor connection 46 (between the towed platform 1 and the linear motor 15) relative to the forward motor connection 47. The pitch of the linear motor 15 is a reference value of zero. The trailing connection 46 may decrease in length (e.g. elastic or comprising a spring) to decrease the pitch of the towed platform 1 as velocity increases. At rest, the linear motor 15 may support the weight of both platforms 1 45 and the fuselage. The forward motor connection 47 comprises a forward joint 4 as previously described, and the forward motor connection 47 may include an arm to increase initial space between the linear motor 15 and the towed platform 1.

Drones with Platforms—FIG. 23 illustrates a drone comprising a towed payload compartment platform 88 and a forward joint 89 similar to the towed platform 1 previously described. Unlike the FIG. 1 towed platform 1, the payload compartment platform 88: a) has at least two sheets with a payload compartment between the sheets and b) is VTOL. The FIG. 23 compartment platform 88 is referred to as a freewing 88 for payloads. The compartment platform 88 may stack and extend platforms 1 with solar cells for power.

FIG. 15 illustrates a transformer drone with a payload compartment platform. The transformer drone is a multicopter comprising a multicopter airchassis 102; a forward tilting body 103 pivotably connected [bearing 104] to the airchassis 102 and configured to pivot between a first position 105 associated with a hover flight mode and a second position 106 associated with a forward flight mode. A forward propulsor 107 is part of the front tiltwing 108; herein the forward propulsor 107 is configured to aerodynamically actuate through a range of motion along with the forward tilting body 103 due to aerodynamics about the front tiltwing 108. The forward propulsor 107 is configured for failsafe operation to vertically land without lift from other propulsors such as a midsection propulsor 312.

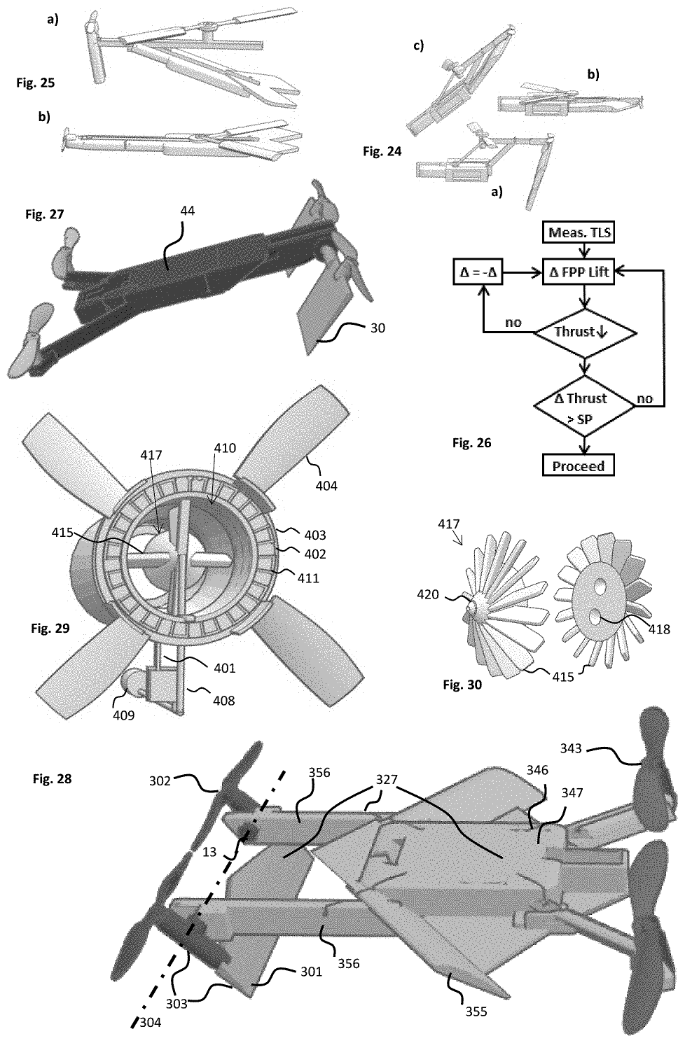

The aerodynamic lift surface of the front tiltwing 103 is configured to: a) approach a near-perpendicular position relative to the airchassis 102 (see FIGS. 15, 24a) in the hovering configuration and b) approach a near-parallel position relative to the airchassis 102 (see FIGS. 24b, 25b) in the cruising configuration. The multicopter further comprises a power supply (110, FIG. 15) configured to control the thrust and lift by providing a variable amount of power to the front tiltwing wherein the control unit (111, 113, 16, or 416) is in communication with the power supply, the control unit having at least one sensor, a processor, and memory storing instructions thereon. When executed by the processor, the control unit calculates at least one of the rate of descent, yaw angle, roll angle, pitch angle or altitude of the front tiltwing based on data provided to the processor by the at least one sensor; and the control unit adjusts at least one of the rate of descent, yaw angle, roll angle, pitch angle or altitude by regulating the amount of power provided to the first propulsor by the power supply via a control signal.

As illustrated by FIG. 15, the power supply (110 or 112) and control unit (111 or 113), may be on the tiltwing, on the airchassis 102, or on other locations including redundant and interconnected configurations. Example sensors include a GPS sensor, level indicator, and velocity indicator; sensors may be built into the control unit (111, 113, 16, or 416).

Propulsors may provide lift and thrust; lift is an upward force and thrust is a horizontal force. The total propulsor force is the vector sum of thrust and lift. During steady-state flight, total lift needed to sustain flight is equal to the total multicopter weight.

In the hovering configuration, the first propulsor of the front tiltwing and the second propulsor of the counterbalance propulsor system are configured to counterbalance the gravitational force acting through the center of gravity of the multicopter. A propulsor (107, 109, or 3) may be one or more of the group: propeller, fan, rotating blade, or exhaust nozzle. In the cruising configuration, the front tiltwing's propulsor generates more thrust than lift, and the front tiltwing's aerodynamic lift surface generates lift.

Preferably, the multicopters of this invention have three failsafe modes (see FIG. 24) of descent, including: a) mostly vertical powered by a midsection rotor, b) mostly horizontal powered by the front tiltwing, and c) mostly vertical powered by the front tiltwing (“a-c failsafe modes”). The failsafe descent is typically triggered by a failure of a propulsor, and so, power from propulsors other than the one powering descent is negligible. An algorithm for using the a-c failsafe modes includes a key failsafe aspect to “dampen” “a)” and “c)” vertical (pseudo-autorotation) descent modes where dampen means to slow done without overdoing propulsor lift (which could lead to out of control roll, yaw, or pitch).

Preferred embodiments include a swaywing or freewing which positions at a location that both a) provides for easier loading and b) reduces resistance to hovering aerodynamics of propulsors producing lift. FIG. 15 illustrates a swaywing 25; a fuselage 44 can be a swaywing.

A midsection rotor is the preferred counterbalance propulsor due to failsafe landing configurations and due to the ability to of the rotary wing (FIG. 25a) to fold to a fixed wing configuration (FIG. 25b). Preferred midsection rotor transition is by aerodynamic actuation where a stopped rotor leads to the fixed-wing position and rotation leads to the rotary wing configuration. A catch may lock a first blade 169 in position relative to the fuselage (or airchassis) when aerodynamic forces cause rotation in a direction reverse that for lift generation; where after, the aerodynamic forces twist the second blade 170 about a radial axis from the rotary wing position to a fixed wing position. Preferably, the rotary wing is configurated to move to a position further away form the vehicle with rotation.

Preferably, the midsection rotor is of a design without a swashplate, and failsafe landing is in a pseudo-autorotation method with a pseudo-hovering configuration. Pseudo-autorotation method means “sort of autorotation method” and refers a moderate power supply to the rotor during descent with an increased in power three to fifteen seconds before landing to dampen landing soften the landing. The pseudo-hovering configuration is one in which a rotary wing or propulsor of a high ratio of upward force relative to weight (e.g. the high ratio is >0.4) passively positions above a fuselage of a lower ratio of upward force relative to weight. The upward force is a sum of lift and drag vertical vectors. A front tiltwing is located in front of the fuselage center of gravity, and the passive stability features of a front tiltwing causes formation of the auto-hovering configuration at forward velocities less than 50 miles per hour (mph) when there is negligible lift from the counterbalance propulsor and when lift-path lift is inadequate to maintain a cruising configuration. The front tiltwing is blocked from having a lower pitch (more nose up is more positive) than the airchassis by devices such as the airchassis 102.

Preferably the multicopter comprises a plurality of longitudinally-extending lift-generating surfaces 327 forming a total aerodynamic lift surface area, the plurality of longitudinally-extending lift-generating surfaces comprising [a]the fuselage, the front passively-adjusting tiltwing, an arm mechanically connecting the front passively-adjusting tiltwing to the fuselage, and platform surfaces 9 10. The plurality of longitudinally-extending lift-generating surfaces align to form a liftpath in a cruising configuration. Preferably, a single front tiltwing is in front of a single fuselage. Preferred is lift of the front passively-adjusting tiltwing at less than half the lift provided by the total aerodynamic lift surface area.

Swaywings and freewings of this invention are types of fuselages. For vehicles without a swaywing or freewing, the airchassis is part of the fuselage.

Three Failsafe Modes and Midsection Rotary Wing—The afore-mentioned a-c failsafe modes are a plurality of failsafe methods for landing a multicopter where the multicopter comprises a front tiltwing, a vehicle center of gravity, a front tiltwing propulsor thrust, a front tiltwing propulsor lift, a front tiltwing propulsor force, a ratio of tiltwing propulsor thrust to lift, a front tiltwing propulsor lift, a total multicopter lift, a total multicopter thrust, a first failsafe method, and a second failsafe method. The first failsafe method (FIG. 24b) comprises transitioning the front tiltwing to a position wherein the total multicopter lift is more than four times greater than the front tiltwing propulsor lift and the tiltwing propulsor thrust is at least eighty percent of the total multicopter thrust. The second failsafe method (FIG. 24c) comprises transitioning the front tiltwing to a position where the front tiltwing propulsor lift is greater than one third of the total multicopter lift and the tiltwing propulsor lift is greater than the total multicopter thrust. Preferably, passive aerodynamic actuation transitions the tiltwing for the first failsafe method and second failsafe method. The passive aerodynamic actuation is a result of the inherent stability of the front tiltwing against stall where tiltwing propulsor thrust induces the failsafe mode. The third failsafe method (FIG. 24a) comprises transitioning a midsection rotary wing from a fixed wing position to a rotary position where the midsection rotary wing is coupled to and extends above an airchassis, and the midsection rotary wing is coupled to a power supply and a control unit. Preferred pseudo-autorotation increases and maintains lift from a propulsor or blade to >70%, preferably >99%, of the multicopter weight at least one second before impact.

The Pseudo-autorotation method increases power to propulsor just prior to landing, the rate of descent is decreased while the yaw/roll/pitch increase has not had adequate time to catastrophically roll, flip, or spin the vehicle. Just prior to landing is about 8 seconds prior to landing, but could be greater or less depending on the specific situation. Preferably, yaw is controlled by aerodynamic forces acting on vanes 114 of a duct 115 surrounding the midsection rotary wing or a tiltwing propeller, whereby the vanes 114 are configured such that aerodynamic forces on the vanes 114 provide partial yaw control. For a vehicle without a swaywing, the configuration for the first and second failsafe methods are the same with the vehicle nose upward in the tiltwing's hover failsafe landing configuration.

The second failsafe method is enabled by a front tiltwing propulsor force vector that provides a minimum torque about that center of gravity. In general, minimum torque corresponds to the closest distance of approach of the extended force vector being less than half the median width of the aircraft fuselage.

A Most-Preferred Multicopter—Preferably at least one aileron 118 is on the front tiltwing 108 configured to provide roll control, most preferably including enabling of yaw control from propeller downwash.

FIG. 15 also identifies hardware for failsafe algorithm control comprised of: a an airchassis 102; b a single front tiltwing 108 extending in front of the airchassis 102 said front tiltwing 108 comprising a tiltwing propulsor configuration 107, an aerodynamic lift surface 347, a tiltwing power supply 110, and a tiltwing control unit 111. The control unit 111 comprises a control signal to control the tiltwing thrust (e.g. a speed control system) and communication by hard wire or transmitter-receiver communication.

More preferred operation is a wherein the hovering configuration 105 comprises a balancing of downward force on the center of gravity, lift from the front tiltwing 108, and lift from the counterbalance propulsion configuration.

As a publication, PCT/US20/36936 application filed on Jun. 10, 2020 entitled “Multicopter with Improved Propulsor and Failsafe Operation” provides operational details related to Swaywing Positioning and Forces, Torques, and Passive Actuation to complete embodiments of this document.

Preferred Motor—Preferred propulsors of this invention include electric motors. The preferred motor has a high power density and simple, inexpensive modular design. That preferred motor is based around a stator embodiment that may be used in both motor and generator applications. The stator discs 514 and stacked-disc configurations 521 523 may be used in generators in synchronous configurations.

Preferably: a) the motor comprises a plurality of induction circuits on each stator disc of the plurality of stator discs of the stator system; b) the plurality of stator discs are fabricated by at least one of 3D printing, metal stamping, laser cutting of sheet metal, or pressing of a metal wire; c) two stators from the plurality of stator discs are adjacently mounted on the circuit busbar forming a 1.5 loop stacking, the 1.5 loop stacking having an induction circuit with four radial direction tracks, an inner angular direction track, and an outer direction track, and d) the motor comprises a 1.5 loop stacking 528 (see FIG. 6c) said 1.5 loop stacking 528 comprising two of the each stator discs 502 adjacently mounted on the circuit busbar 506 forming adjacently-mounted sections cumulatively forming an induction circuit 510 comprising four radial-direction tacks 503, an inner conductive angular-direction track 504, and an outer conductive angular-direction track 504.

Several options exist for the at least one rotor system. The rotor system may include: a conductive metal disc, a primary coil coupled to a rotating secondary coil and attached to a housing, an induction circuit (a continuous conductive track from connector to connector), a permanent magnet and a magnetic bearing through interaction with stator induction circuits 510. The preferred rotor system is configured to be turned via electromagnetic induction forces. Preferred stator disc configurations include: a three phase configuration comprising three angular orientations of the stator discs 502 aligned along the common axis 507, a six phase configuration comprising six angular orientations of the stator discs aligned along the common axis, a two phase configuration comprising two angular orientations of the stator discs aligned along the common axis 507, and a four phase configuration comprising four angular orientations of the stator discs 502 aligned along the common axis.

To assemble, a busbar shaft 531 may be designed to fit through the holes of the discs including slots through which connective busbar clips pass. A matching key on the connective clips allows a twisting action (same direction as rotor rotation) to friction fit the connective clips to the disc's terminals 505. The connection clips are designed to connect the disc terminals 505 to appropriate circuits on the busbar. The busbar may connect the disc circuits in series or parallel. Preferably, the busbar connects the disc circuits in series by alternating the ground and live wire connection along the busbar's axial length and at locations of connectivity to the discs. Washers may be used as locking devices.

3D-Printed Parts—A method for joining 3D-printed smaller structures to form a structural body may be used to produce multicopter surfaces at larger scales. A preferred structural body is comprised of a first body 250 and a second body 251 with a connector 252 having a duct 253 for flow of thermoset resin between body mold cavities 254 said cavities 254 open to an injection port 255, said duct 253 open to flow between the first body 250, and second body 251. This is illustrated by FIG. 5b.

Fabrication steps required to make the structural body include: a) fabricating the first body 250 and second body 251 by a method such as 3D printing, b) connecting the bodies with the connector, c) injecting a curing-type resin (e.g. thermoset resin) into the injection part with flow of the resin through the cavities 254 and duct, and d) allowing the resin to set forming a polymer in the cavities 254 which are a mold for the resin.

Examples of connectors 252 include a ferrule connector and male inserts held in place by friction. A slot 256 may be used to facilitate slipping a male connector of the first body 250 into the female counterpart of the second body 251. The female counterpart comprises a space conforming to the male connector 252 as is common in the art. Also, the female counterpart must be open to the cavity in the second body. Examples of connectors include rivet-type molds where resin flows through the rivet and sets to connect two parts.

Preferably, the structural body contains at least one vent port 257 at an upper portion of the mold cavity 254 to allow gases to escape therein allowing resin to more-effectively fill the cavities 254. The joining surface of connecting bodies may have multiple connectors; and the connectors may have shapes and locations that better enable 3D printing. Vent ports 257 should be located at mold locations distant from the injection port 255.

3D printing of multicopter components provides for rapid prototyping and easy CAD modification with iterations in prototyping; however, the structural properties of most 3D print filaments and resins are inferior to high performance thermoset polymers. A preferred method to realize the benefits of high-performance thermoset polymers is to incorporate injection ducts and cavities in the 3D-printed components wherein the cavities are strategically placed at locations and shapes to provide extra strength where needed and wherein the ducts connect the cavities to an entrance and vent port for injecting a reacting thermoset resin. The vent port 257 is smaller (e.g. 0.2 to 1.5 mm dia.) than the injection port 255 (e.g. 2 to 5 mm dia.) so as to accommodate exiting air rather than exiting resin.

A further embodiment (FIG. 5c) is a structural body wherein a longitudinal tension device 258 is in the cavity 254 and the thermoset polymer forms around the tension device 258. Preferably, the tension device 258 is in a deflected position from end-to-end of the structural body when used (straight when molded). Here, “deflected position” may be created by a vertical bar 259 near the longitudinal midsection of the cavity 254.

Tension may be provided by clips or nuts 260 attached to the tension device 258 that push against the ends of the shell of the mold 254; preferably, an auxiliary structure is used to place tension on (and straighten) the tension device 258 when a resin is injected and cures. Example tension devices 258 are a cable and a belt. For lighter-density foams, use of a belt is advantageous to reduce localized compression forces that could crush the foam. The structural body is configured to form an injection mold around the tension device 258, similar to the first body 250 and a second body 251 as previously described. The polymer or concrete that forms in the mold 254 supplements longitudinal compression strength that vectors into reduced vertical deflection by encasing the tension device 258 in a rigid matrix. Application of this technology is to make stronger and larger parts from smaller 3D printed parts including use to 3D print multicopters and to make light-weight structural beams.

Preferred Lift-Distribution Algorithm—Flat plate airfoils (i.e. chord>span) have rapidly increasing L:D>50 as pitch (same as air angle of attack) proceeds from 1° to 0° with a singularity at 0°. Better wings (i.e. chord<0.5 span) will tend to have pitch ranges of at least 6° where L:D is >15 (but typically less than 70). The FIG. 26 preferred algorithm realizes the best of both airfoil types. Definitions for this algorithm include: change or change in (A), Thrust Load Signal (TLS) which is a function of total thrust, Flat Plate Platform (FPP) which is actively controlled by a force transfer device between the FPP and wing, and set point (SP). SP is a threshold value of change sufficient to warrant adjustment. In more-general terms, this algorithm seeks to minimize thrust by transferring lift between a platform and a wing. A linear actuator in series with a spring that connects the platform 1 to the wing (in addition to a pivotable joint) is an example of a force transfer device.

A statistical process control (SPC) method is also a good option. An SPC method is based around a target velocity at a target pressure (e.g. 400 mph at 0.2 atm for cruising, 130 mph @ 1.0 atm for takeoff) and a targeted load. SPC is achieved by configuring a wing size/design that provides a 0.2° to 2° pitch on the FPP for cruising, 3° to 7° pitch on the FPP for takeoff, and preferably both. More preferred for cruising is a pitch between 0.3° and 1°.

Preferred Hybrid Engine—For higher-speeds (e.g. >300 mph) the preferred aerial vehicle propulsor is a hybrid engine in which the same fuel (e.g. hydrogen, ammonia) is used to provide power to fuel cells and a combustor such as illustrated by FIGS. 183 and 27. A preferred hybrid electric-fuel engine comprises an electric motor, a motor circuit 401, an axial-flux stator 402, a rotor 403, a propeller 404, a longitudinal axis 405 of rotation, a fuel cell 406, a combustor, a combustor discharge nozzle 407, a fuel line 408, a first thrust mode, a second thrust mode, and a fuel tank 409. The said axial-flux stator 402 comprises an open core 410, a connection to an aircraft, electromagnetics angularly spaced around the core, and an axial air flow through the core and along the longitudinal axis 405 of rotation, wherein the axial-flux stator 402 is configured to rotate the rotor 403 and propeller 404 to provide propeller 404 thrust. The motor circuit 401, fuel cell 406, fuel line 408, and fuel tank 409 are configured to power the axial-stacked stator 402. The combustor comprises an air entrance 412, an air exit 413, and a fuel nozzle 414, said combustor is configured with the fuel line 408 and fuel tank 409 to provide jet thrust. The first thrust mode comprises only propeller 404 thrust, and the said second thrust mode comprises both propeller 404 thrust and jet thrust.

More preferably, the open core 410 is configured to direct air into the air entrance 412; where the directed air may be from 5% to 100% of the air flowing through the core. A propeller 404 thrust efficiency is defined as thrust energy divided by the energy of the fuel used to generate that thrust. A jet thrust efficiency defined as thrust energy divided by the energy of the fuel used to generate the jet thrust. Preferred operations comprise a control system 416 and a transition velocity for transitioning from the first thrust mode to the second thrust mode where the transition velocity is where the propeller 404 thrust efficiency has decreased with increasing velocity until it is equal to the jet thrust efficiency. Propeller 404 blades may extend radially into the open core 410, radially outward, or both radially inward and outward; and the propeller 404 blades may fold back at higher velocity to enable a thrust mode without propeller 404 operation such as a ram jet mode of operation.

More preferably, a freely rotating combustor 417 with blades 415 rotates about the longitudinal axis 405 of rotation near the air entrance 412 and within the open core 410 and comprising a fuel inlet, a fuel nozzle 414, a combustion bell 418, a forward blade surface, and trailing blade surface said combustion bell 418 located on the trailing side of the rotating combustor 417 between the forward and trailing blade surfaces. The nozzle discharges fuel in the combustion bell 418 and the fuel burns to form a thrust wherein the rotating combustor 417 is configured to vector thrust in both angular and forward directions. Preferably, the angular rotation directs air into the combustor to feed the combustion bell 418 with air.

Combustion generates a burner thrust on the rotating combustor 417, and the burner thrust is transferred to an aircraft to sustain or achieve higher-velocity flight. Velocities may exceed mach 1. More-preferred rotating combustor's blades 415 are high-pitch blades 415 with preferred pitch angles between 50 and 85 degrees. This translates to subsonic blade velocities even when velocities are supersonic. Preferably, multiple blades are spaced angularly and longitudinally on the rotating combustor to allow thrust transfer along the entire vertical-lateral plane extending around the rotating combustor to duct walls 419 containing the combustion. Duct walls 419 may be the same as core walls, or they may be separate when a propeller 494 (i.e. fan) rotates inside the core.

The rotating combustor is configured to rotate with minimal resistance to air flow while providing a surface for burner thrust to be directed to the aircraft to which the hybrid electric-fuel engine is connected. FIG. 30 shows a bearing sleeve 420 on which a bearing is mounted to enable rotation and thrust force transfer. The preferred rotating combustor comprises centrifugal air flow vanes on the front surface nose, multiple high pitch blades, back-side combustion bells, and backside surfaces configured to collect thrust force in a mostly forward vector but with complement to rotation to optimize performance.

The embodiments of this invention have common applications in solar planes and transformer drones. This invention includes use of the embodiments in combinations and applications beyond specific illustrations of this document.

The FIG. 32 exploded view of an induction device illustrates a three-phase configuration with each phase comprising two discs connected in a parallel circuit. The FIG. 32 induction device has outer perimeter electrical connectivity and is preferably paired with an induction device having electrical connectivity along an inner perimeter such as illustrated by FIG. 10a to form coupled stackings of induction devices, wherein there is a rotation one of the coupled devices relative to the other coupled device. More specifically, either of the coupled devices may be the rotor with the other being the stator.

By example, the FIG. 32a induction device may be the rotor, wherein the reaction the reaction element is a rotor comprising a rotor induction circuit on a rotor board, said rotor board configured with cores of similar size and geometry as stator board induction circuits. Also, said rotor board may be one of a plurality of rotor boards, said plurality of rotor boards of a configuration selected from the group comprising: parallel closed-circuit rotor induction circuits, parallel rotor induction circuits configured at phase angles equal to stator board phase angles, parallel rotor induction circuits configured to interact with a stationary excitation magnetic field system in an induction generator (said induction generator configured to convert rotational energy to electrical current), and parallel rotor induction circuits configured to interact at least one core of one of the stator boards in an induction generator (said induction generator configured to convert rotational energy to electrical current). FIG. 33 illustrates a stationary solenoid 585 as the source of the stationary excitation magnetic field. The control unit 586 preferably control a plurality of circuit connectivity options 587 made possible by the busbar connection circuits. The control unit optionally is in communication with the stationary solenoid to enable the FIG. 33 device to switch from induction motor operation to induction generator operation.

Preferably, the solenoid 585 is configured for high reluctance provided by a larger relative magnetic core mass with a coils of multiple turns and lower DC current. Operational configurations include a configuration where the solenoid's magnetic field induces a current in a rotating rotor board, and wherein, the induced current is transferred to a stacked rotor coupled with a stator of matching phase and core configuration. The configuration approaches generation of pure DC current in the stator system available for used by external circuits.

1. A stator system comprising:
an induction circuit, said induction circuit comprising:
a sequence of a radial-direction track coupled to an angular-direction track, said sequence extending along a surface between said stator system and a fluid;
wherein a track is a conductive material and may include electrical insulation on said track's outer surface;
wherein the stator system is configured to generate electromagnetic induction forces.

2. The stator system of claim 1 wherein said stator system is a stator of an induction device; said induction device is selected from the group comprising: a rotary motor, a generator, a brake, a damper, a linear motor, a rotary induction motor, a servo, an axial flux rotary motor, and a surrogate solenoid device.

3. The stator system of claim 1; further comprising a terminal-to-terminal induction circuit; said terminal-to-terminal induction circuit is an induction circuit extending between a first terminal and a second terminal; wherein half or more of the induction circuit's resistance heat transfers directly to said fluid.

4. The stator system of claim 1;
said stator system coupled with a rotor system in an induction motor;
said induction motor comprising adjacent induction circuits, said adjacent induction circuits sharing common and continuous electromagnet cores, said adjacent induction circuits configured to generate magnetic fields at different phase angles.

5. The stator system of claim 1 further comprising:
a plurality of stator discs configured substantially symmetric about a common axis, said stator discs comprising a plurality of terminal-to-terminal induction circuits;
and a plurality of gaps between said stator discs;
wherein said stator system is configured as a stator of a motor, said motor comprising at least one rotor.

6. The stator system of claim 5;
said plurality of stator discs further comprising stator disc cores comprised of materials selected from the group comprising: ferromagnetic composite, ferromagnetic metal, air, and water;
wherein the motor is one selected from the group comprising: a three-phase induction motor, a six-phase induction motor, a two-phase induction motor, a four-phase induction motor.

7. The stator system of claim 1 further comprising a plurality of stator discs configured as a stator of an induction motor,
said induction motor comprising a rotor system, said rotor system comprising a conductive-metal surface.

8. The stator system of claim 1 further comprising a first induction circuit having first axial tracks and a second induction circuit having second axial tracks;
wherein said stator system is configured to generate an electromagnetic field and accelerate a reaction element;
wherein said first axial tracks are parallel to said second axial tracks.

9. The stator system of claim 8 wherein the reaction element is selected from the group comprising: rotor, slider, lever arm, a ferromagnetic rod, circuits, and a conductive surface configured to generate induced current.

10. The stator system of claim 8;
said first induction circuit and said second induction circuit further comprising multiple electromagnetic core perimeters;
said reaction element further comprising a rotor induction circuit and core perimeters of similar size and geometry as the first induction circuit;
wherein the reaction element is an induction rotor configured for flow of current in said rotor induction circuits.

11. The stator system of claim 10;
wherein said rotor induction circuit is one of a plurality of rotor induction circuits;
wherein said plurality of rotor induction circuits are of a configuration selected from the group comprising:
parallel closed-circuit rotor induction circuits,
parallel rotor induction circuits configured at phase angles equal to stator board phase angles,
parallel rotor induction circuits configured to interact with a stationary excitation magnetic field system in an induction generator, said induction generator configured to convert rotational energy to electrical current,
and parallel rotor induction circuits configured to interact at least one core of one of the stator boardss in an induction generator, said induction generator configured to convert rotational energy to electrical current.

12. An engine comprising:
rotating blades, said rotating blades comprising compressor blades and expander blades;
and a combustion pressure volume, said combustion pressure volume comprising a fluidic radial surface;
wherein rotation of said compressor blades is coupled with rotation of said expander blades;
wherein said engine is configured for the rotating blades to contain at least one third of the fluidic radial surface.

13. The engine of claim 12 further comprising a compressor comprising said compressor blades, an expander comprising said expander blades, and a coupling means;
wherein said coupling means is selected from the group comprising: a shaft, a connection at the outer radius of rotation of at least some of the expander blades, and a magnetic induction device;
wherein said compressor is selected from the group comprising: a turbine, a propeller, and a fan;
wherein said expander is selected from the group comprising: a turbine, a propeller, and a fan;
wherein said engine is selected from the group comprising: a jet engine, a gas turbine, and hybrid electric-fuel jet engine.

14. The engine of claim 12 further comprising an electric motor;
wherein said engine is configured to sustain flight with or without fuel use;
wherein said compressor is a leading compressor, said expander is a trailing expander, and the combustion pressure volume is longitudinally located between said compressor and said expander.

15. The engine of claim 12 further comprising a plurality of pressure volumes, said pressure volumes comprising an outer pressure volume and an inner pressure volume;
wherein the inner pressure volume is fully contained in the outer pressure volume;
wherein the inner pressure volume has a higher pressure than the outer pressure volume;
wherein combustion occurs in the inner pressure volume;
wherein said inner pressure volume has an inner expander trailing said inner pressure volume;
wherein said outer pressure volume as an outer expander trailing said outer pressure volume.

16. A hybrid engine comprising an electric motor with a rotor and a combustor,
said electric motor comprising an open motor core positioned around a longitudinal axis of rotation;
said combustor located between a leading compression section and a trailing expansion section;
wherein air flows through said open motor core to the combustor;
wherein said hybrid engine is configured to transition from electric-powered propulsion to propulsion with both electric and jet power.

17. The hybrid engine of claim 16 further comprising:
a combustor configured to sustain fuel combustion in air having entering velocities greater than mach 0.8,
a bell nozzle trailing the combustor and configured to expand combustion gases, and
a compression blade assembly configured absorb an impulse force generated by acceleration of gases during combustion.

18. The hybrid engine of claim 16;
wherein said leading compression section is connected to a first electric motor rotor;
wherein said trailing expansion section is connected to a second rotor;
wherein the motor is configured to transfer power from the second rotor to the first rotor.

19. The hybrid engine of claim 16 wherein electric motor is at least one configuration selected from: a) a motor configured to initiate propeller rotation, b) a motor configured to supplement jet engine power, c) a generator configured to recover energy from propeller rotation, and d) an induction device configured to transfer power from a trailing expander to a leading compressor.

20. The hybrid engine of claim 16 further comprising a fast stator and a slow stator, said slow stator coupled to a propeller through a slow rotor.
